(19) United States
(12) Patent Application Publication
(10) Pub. No.: US 2026/0134502 A1
(43) Pub. Date: May 14, 2026

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventor: Gaku NAKANO, Tokyo (JP)

(73) Assignee: NEC Corporation, Tokyo (JP)

(21) Appl. No.: 19/358,811

(22) Filed: Oct. 15, 2025

(30) Foreign Application Priority Data
Nov. 14, 2024 (JP) 2024-199022

(51) Int. Cl. G06T 3/04; G06T 7/73

(52) U.S. Cl. CPC G06T 3/04; G06T 7/74

(57) ABSTRACT

An information processing apparatus includes a related point detection unit that extracts feature points having scale information and angle information from each of two images obtained by imaging the same object from different directions, and detects a pair of the feature points related between the images from among the extracted feature points, a related figure detection unit that detects, for each pair of the feature points, a pair of figures that are derived from the feature points and are related between the images by using a position and one of the scale information and the angle information of each feature point constituting the pair, and a transformation matrix generation unit that generates a homography matrix for transforming one of the images into the other by using equal to or more than three pairs of the figures.

This application is based upon and claims the benefit of priority from Japanese patent application No. 2024-199022, filed on Nov. 14, 2024, the disclosure of which is incorporated herein in its entirety by reference.

### TECHNICAL FIELD

The present disclosure relates to a technology for generating a homography matrix.

### BACKGROUND ART

Transformation for connecting images in a plurality of images obtained by imaging a certain plane from different angles is referred to as a homography. The homography is represented by a 3×3 matrix, and is transformation that makes a certain quadrangle into another quadrangle. Therefore, it is known that a homography matrix can be generated when four different points on the plane can be observed on the images. JP 7334058 B2 discloses a technology for detecting equal to or more than four pairs of related feature points (hereinafter, simply referred to as related points) from between two images, and applying a direct linear transform (DLT) method to the detected related point pairs to convert a bird's eye view image of a sports scene into a frontal view. JP 7448034 B2 discloses a technology for generating a homography matrix by equal to or more than two related point pairs by using feature points for calculating a scale and an angle in addition to image coordinates. Such feature points are extracted by calculating a scale invariant feature transform (SIFT) feature value or a speeded-up robust features (SURF) feature value from an image.

According to the technology disclosed in JP 7448034 B2, as compared with the technology disclosed in JP 7334058 B2, the minimum number of pairs of the related point pairs used for the generation can be reduced from four to two, and thus an effect of reducing the number of trials in combination optimization such as random sample consensus (RANSAC) is expected.

### SUMMARY

However, the homography matrix generation method using the two related point pairs disclosed in JP 7448034 B2 has a problem that accuracy of the homography matrix is low. That is, in the feature point calculated by the SIFT or the SURF, the coordinates, the scale, and the angle each include an estimation error, but in the technology disclosed in JP 7448034 B2, since error distributions of these are treated as the same, there arises the problem that the accuracy of the homography matrix is low.

For example, the scale and the coordinates of the feature point extracted by the SIFT feature value are estimated in units of subpixels by approximating a difference of Gaussian (DoG) value around the feature point as a quadratic surface and obtaining an extreme value. On the other hand, the angle of the feature point is determined as a discrete maximum value of a histogram with a fixed number of bins. In this manner, the position, the scale, and the angle of the feature point are obtained by the different methods, and thus have the different error distributions. Therefore, when it is assumed that these are based on the same error distribution, the accuracy of the generated homography matrix decreases. As a result, the number of trials in the RANSAC is not reduced according to a theoretical value even though the two related point pairs are used.

An example of an object of the present disclosure is to suppress a decrease in accuracy of a homography matrix in generation of the homography matrix using two related point pairs.

In order to achieve the above object, an information processing apparatus in one aspect of the present disclosure includes
a related point detection unit that extracts feature points having scale information and angle information from each of two images obtained by imaging the same object from different directions, and detects a pair of the feature points related between the images from among the feature points extracted from the two images,
a related figure detection unit that detects, for each pair of the feature points, a pair of figures that are derived from the feature points and are related between the images by using a position and one of the scale information and the angle information of each feature point constituting the pair, and
a transformation matrix generation unit that generates a homography matrix for transforming one of the images into the other by using equal to or more than three pairs of the figures related between the images.

In order to achieve the above object, an information processing method in one aspect of the present disclosure includes
a related point detection step of extracting feature points having scale information and angle information from each of two images obtained by imaging the same object from different directions, and detecting a pair of the feature points related between the images from among the feature points extracted from the two images,
a related figure detection step of detecting, for each pair of the feature points, a pair of figures that are derived from the feature points and are related between the images by using a position and one of the scale information and the angle information of each feature point constituting the pair, and
a transformation matrix generation step of generating a homography matrix for transforming one of the images into the other by using equal to or more than three pairs of the figures related between the images.

In order to achieve the above object, a computer-readable recording medium in one aspect of the present disclosure records a program including a command for causing
a computer to execute
a related point detection step of extracting feature points having scale information and angle information from each of two images obtained by imaging the same object from different directions, and detecting a pair of the feature points related between the images from among the feature points extracted from the two images,
a related figure detection step of detecting, for each pair of the feature points, a pair of figures that are derived from the feature points and are related between the images by using a position and one of the scale information and the angle information of each feature point constituting the pair, and
a transformation matrix generation step of generating a homography matrix for transforming one of the images into the other by using equal to or more than three pairs of the figures related between the images.

As described above, according to the present disclosure, it is possible to suppress a decrease in accuracy of a homography matrix in generation of the homography matrix using two related point pairs.

### BRIEF DESCRIPTION OF THE DRAWINGS

FIG. 1 is a diagram illustrating an example of a pair of feature points related between images;

FIG. 2 is a configuration diagram illustrating a schematic configuration of an example of an information processing apparatus;

FIG. 3 is a configuration diagram specifically illustrating a configuration of a first example of the information processing apparatus;

FIG. 4 is a diagram illustrating an example of a related point pair and a related figure pair;

FIG. 5 is a flowchart illustrating a first example of operation of the information processing apparatus;

FIG. 6 is a diagram illustrating an example of a pair of regions related between images;

FIG. 7 is a flowchart illustrating a second example of the operation of the information processing apparatus; and

FIG. 8 is a block diagram illustrating an example of a computer that achieves the information processing apparatus.

### EXAMPLE EMBODIMENT

### (Premise Description)

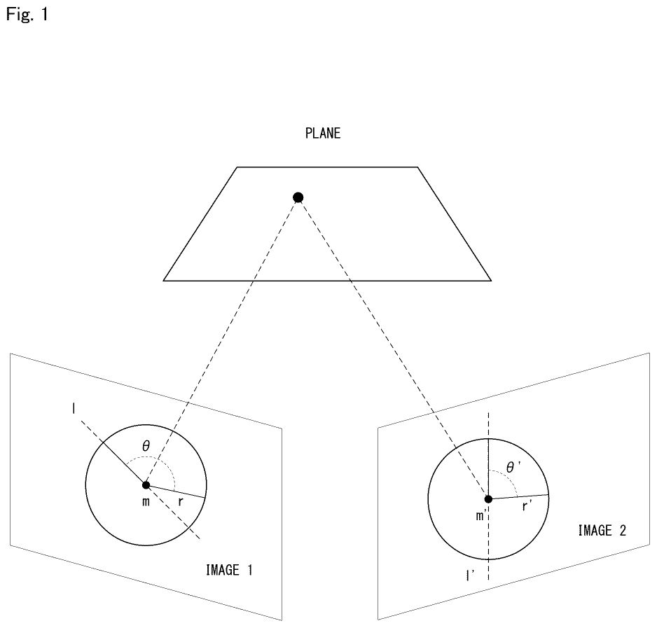

First, matters that serve as a premise of the present disclosure will be described with reference to FIG. 1. FIG. 1 is a diagram illustrating an example of a pair of feature points related between images. In the example of FIG. 1, an image 1 and an image 2 are obtained by imaging the same object from different directions.

Specifically, as illustrated in FIG. 1, a certain point on a plane is imaged from different angles. As a result, a feature point m in the image 1 and a feature point m′ in the image 2 are observed. The feature point m and the feature point m′ constitute a related point pair obtained by observing the point on the same plane on the different images. Hereinafter, the pair of feature points related to each other is also referred to as the “related point pair”.

Such feature points are extracted by calculating, from image data of the images, a scale invariant feature transform (SIFT) feature value or a speeded-up robust features (SURF) feature value, for example. Such feature points extracted from the feature value have scale information and angle information.

The scale information indicates a region in which the feature value is within a set range with the feature point as a center. In the example of FIG. 1, the scale information is indicated by a circle having a radius r centered on the feature point. The angle information indicates a direction of the feature point obtained from a gradient direction histogram of luminance in the region centered on the feature point. In the example of FIG. 1, it is indicated by θ.

As illustrated in FIG. 1, the feature point m has a scale r and an angle θ as the scale information and the angle information. The feature point m′ related to the feature point m has a scale r′ and an angle θ′ as the scale information and the angle information. A line l in the image 1 is a straight line having an inclination θ passing through the feature point m. Similarly, a line l′ in the image 2 is a straight line having an inclination θ′ passing through the feature point m′.

### First Example Embodiment

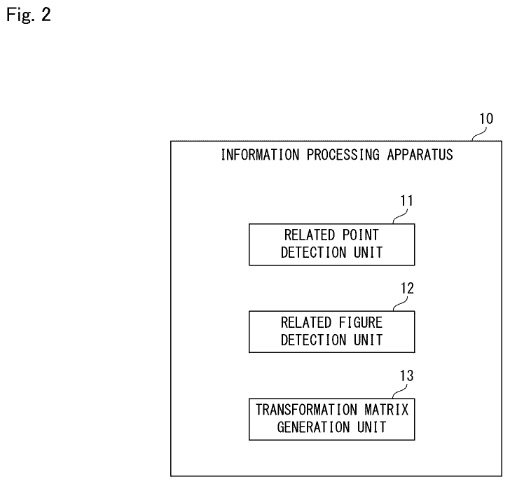

Hereinafter, an information processing apparatus, an information processing method, and a program in a first example embodiment will be described with reference to FIGS. 2 to 5.

### [Apparatus Configuration]

First, a schematic configuration of an example of the information processing apparatus will be described with reference to FIG. 2. FIG. 2 is a configuration diagram illustrating the schematic configuration of an example of the information processing apparatus.

An information processing apparatus 10 illustrated in FIG. 2 is an apparatus for generating a homography matrix between images, in other words, a homography matrix generation apparatus. As illustrated in FIG. 2, the information processing apparatus includes a related point detection unit 11, a related figure detection unit 12, and a transformation matrix generation unit 13.

The related point detection unit 11 extracts feature points having scale information and angle information from each of two images obtained by imaging the same object from different directions. The related point detection unit 11 then detects a pair of related feature points (related point pair) between the images from among the feature points extracted from the two images.

The related figure detection unit 12 detects, for each related point pair, a pair of figures that are derived from the feature points and are related between the images by using a position and at least one of the scale information and the angle information of each feature point constituting the related point pair.

The transformation matrix generation unit 13 generates, by using equal to or more than three pairs of the related figures between the images, a homography matrix for transforming one of the images to the other.

In this manner, the information processing apparatus 10 generates the homography matrix by using not only the related point pairs but also the pairs of related figures (hereinafter, referred to as “related figure pairs”) between the images. Therefore, according to the information processing apparatus 10, it is possible to suppress a decrease in accuracy of the homography matrix in the generation of the homography matrix using the two related point pairs.

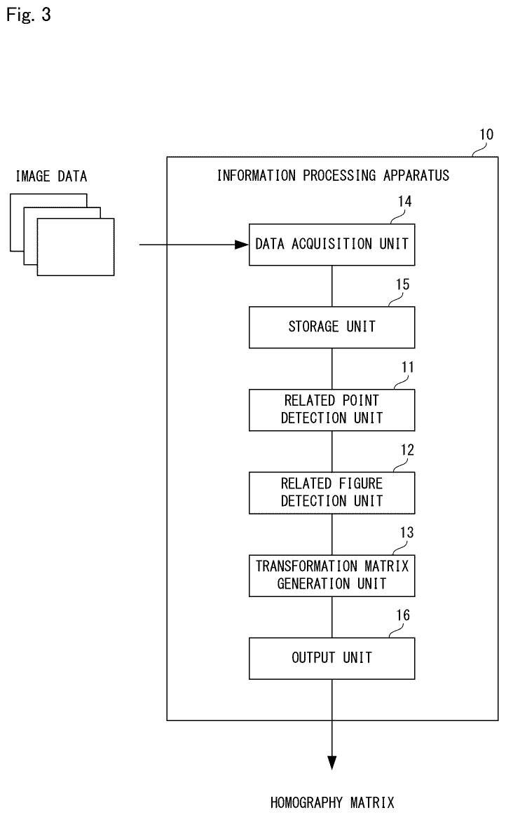

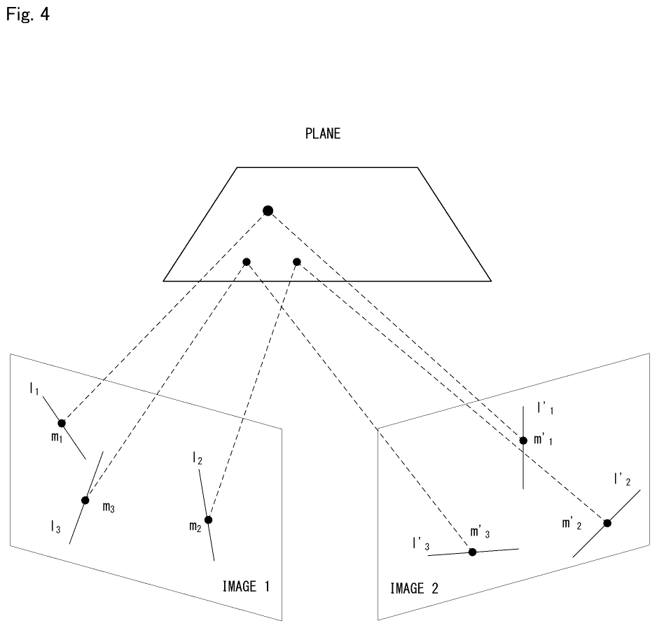

Subsequently, the configuration and the function of the information processing apparatus 10 will be more specifically described with reference to FIGS. 3 and 4. FIG. 3 is a configuration diagram specifically illustrating a configuration of a first example of the information processing apparatus. FIG. 4 is a diagram illustrating an example of the related point pair and the related figure pair.

As illustrated in FIG. 3, the information processing apparatus 10 includes a data acquisition unit 14, a storage unit 15, and an output unit 16 in addition to the related point detection unit 11, the related figure detection unit 12, and the transformation matrix generation unit 13 described above.

The data acquisition unit 14 acquires, from an external device, for example, a server device, a terminal device, or an imaging device, image data of the images obtained by imaging the same object from the different directions, and stores the acquired image data in the storage unit 15.

In the example embodiment, the related point detection unit 11 first extracts image data of two images (an image 1 and an image 2) from the storage unit 15, and extracts feature points from each image of the two pieces of extracted image data. Specifically, the related point detection unit 11 extracts the feature points by calculating, for example, a scale invariant feature transform (SIFT) feature value or a speeded-up robust features (SURF) feature value in each image.

The related point detection unit 11 then detects equal to or more than three related point pairs by applying an existing feature point matching technology to the extracted feature points. As described above, each of the extracted feature points has the scale information indicated by a radius r and the angle information indicated by an angle θ.

In the example embodiment, the related figure detection unit 12 specifies a virtual line passing through each feature point by using the position and the angle information of each feature point constituting the related point pair for each of the equal to or more than three extracted related point pairs, and detects the specified virtual lines of the feature points as the related figure pair.

Specifically, as illustrated in FIGS. 1 and 4, when it is assumed that the related point pair includes a feature point mᵢ and a feature point m′ᵢ, the related figure detection unit 12 specifies a line lᵢ that is a straight line passing through the feature point mᵢ and having an inclination θᵢ, specifies a line l′ᵢ that is a straight line passing through the feature point m′ᵢ and having an inclination θ′ᵢ, and sets the specified line lᵢ and line l′ᵢ as the related figure pair. Equal to or more than three related figure pairs are detected in accordance with the number of related point pairs.

The transformation matrix generation unit 13 generates the homography matrix by using equal to or more than three detected related point pairs and equal to or more than three detected related figure pairs.

The output unit 16 outputs the homography matrix generated by the transformation matrix generation unit 13. Examples of an output destination include an image processing apparatus. The information processing apparatus 10 may constitute a part of the image processing apparatus. Examples of the image processing apparatus include an apparatus that generates three-dimensional data of an object from a plurality of images of the object by using a homography matrix.

### [Apparatus Operation]

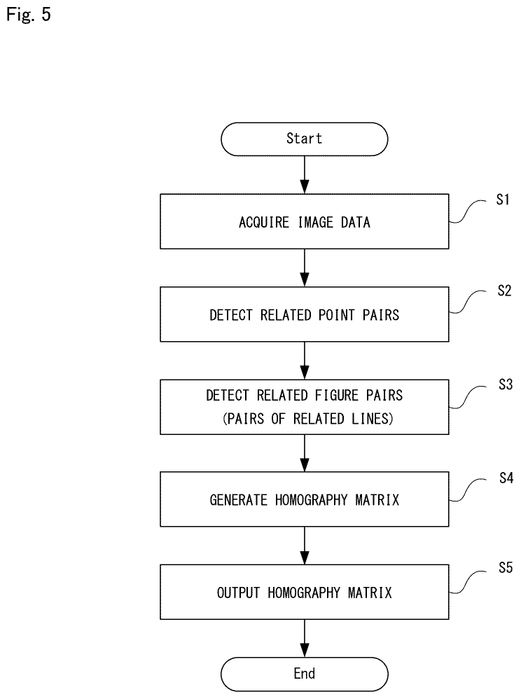

Next, operation of the information processing apparatus 10 will be described with reference to FIG. 5. FIG. 5 is a flowchart illustrating a first example of the operation of the information processing apparatus. FIGS. 1 to 3 will be appropriately referred to in the following description. In the first example embodiment, the information processing method is performed by operating the information processing apparatus 10. Therefore, description of the information processing method in the first example embodiment is substituted with the following description of the operation of the information processing apparatus 10.

As illustrated in FIG. 5, first, the data acquisition unit 14 acquires, from an external device, image data of images obtained by imaging the same object from different directions (step S1). The data acquisition unit 14 stores each piece of the acquired image data in the storage unit 15.

Next, the related point detection unit 11 acquires image data of optional two images (the image 1 and the image 2) from the storage unit 15, executes feature point matching on each image of the acquired image data, and detects equal to or more than three related point pairs (step S2).

Next, for each related point pair detected in step S2, the related figure detection unit 12 detects a pair of lines related as a related figure pair by using a position and angle information of each feature point constituting the related point pair (step S3).

Specifically, in step S3, the related figure detection unit 12 specifies, for each related point pair, a virtual line passing through each feature point by using the position and the angle information of each feature point constituting the related point pair, and detects a pair of the specified virtual lines as the related figure pair.

Next, the transformation matrix generation unit 13 generates a homography matrix by using the equal to or more than three related point pairs detected in step S2 and the related figure pairs detected in step S3 (step S4).

Thereafter, the output unit 16 outputs the homography matrix generated in step S4 (step S5).

In a case where it is needed to generate a homography matrix also between another two images, steps S2 to S5 are executed again. In this case, in step S2, the related point detection unit 11 acquires image data for a different combination of two images.

In step S4, the transformation matrix generation unit 13 can execute the generation of the homography matrix a plurality of times while changing the related figure pair to be used. The transformation matrix generation unit 13 then executes evaluation of accuracy for the plurality of generated homography matrices, and selects a homography matrix with the highest accuracy based on evaluation results.

Examples of a method of selecting a highly accurate homography matrix include, as performed in the RANSAC, a method of applying the generated homography matrices to related point pairs that have not been used for the generation, measuring reprojection errors between related points, and selecting a homography matrix that minimizes a total value of the measured reprojection errors. In this method, instead of the reprojection error, a Sampson error, an algebraic error, or the like, which is a primary approximation of the reprojection error, may be used.

### Specific Example

Here, a specific example of processing in the information processing apparatus 10 will be described below. In the following specific example, coordinates of the feature point are represented by 3×1 homogeneous representation. For example, coordinates of a feature point m and a related feature point m′ are represented by m=[u, v, 1]^{T} and m′=[u′, v′, 1]^{T}. The homography matrix is represented by a 3×3 matrix H. The number of elements of the matrix H is 9, but since there is scale uncertainty, a degree of freedom is 8.

Specifically, a homography of the feature point m and the feature point m′ as the related point pair is represented by the following Expression 1. In the following Expression 1, “˜” represents that both sides are equal to a constant multiple.

$${m}^{′} ∼ Hm \qquad [ Expression 1 ]$$

Subsequently, the related figure pair will be described. As described above, the feature point m has information related to the angle θ as the angle information. Therefore, a straight line l passing through the feature point m is represented by the following Expression 2.

$${l}^{T} m = 0 l = {[ sin θ , - cos θ , v cos θ - u sin θ ]}^{T} \qquad [ Expression 2 ]$$

With the above Expression 1 and the above Expression 2, a homography of the line l and a related line l′ is represented by the following Expression 3.

$${l}^{T} m = {l}^{T} {H}^{- 1} Hm = {{l}^{′}}^{T} {m}^{′} = 0 ↔ {l}^{′} ∼ {H}^{- T} l ↔ l ∼ {H}^{T} {l}^{′} \qquad [ Expression 3 ]$$

Therefore, when N related point pairs and M related figure pairs are given, it is possible to estimate the matrix H by solving an optimization problem represented by the following Expression 4. In the following Expression 4, “x” represents a cross product of three-dimensional vectors.

$${min}_{H} {\sum }_{i = 1}^{N} {‖ {m}_{i}^{′} \times {Hm}_{i} ‖}^{2} + {\sum }_{j = 1}^{M} {‖ {l}_{j} \times {H}^{T} {l}_{j}^{′} ‖}^{2} \\ s . t . {‖ H ‖}^{2} = 1 \qquad [ Expression 4 ]$$

From the above Expression 4, two constraint conditions are obtained from one related point pair “m′ᵢ×Hmᵢ”. As illustrated in FIG. 4, one related figure pair (pair of related lines) is defined for one related point pair. Since the line lᵢ always passes through the feature point mᵢ, one constraint condition is obtained from one related line pair “lⱼ×HTl′ⱼ”. Therefore, in order to solve the above Expression 4, it is needed to satisfy the following Expression 5.

$$2 * N + M ≧ 8 \qquad [ Expression 5 ]$$

The minimum configuration satisfying the above Expression 5 is N=3 and M=2. That is, by using the minimum three related point pairs and two of the three related figure pairs defined by the three related point pairs, the above Expression 5 can be solved, and the matrix H can be generated. As a matter of course, all the three related figure pairs may be used. The above Expression 4 results in a direct linear transformation (DLT) method.

Here, steps S2 to S4 illustrated in FIG. 5 will be described in detail for each step along the above specific example.

### [Step S2]

In step S2, the related point detection unit 11 acquires the image data of the image 1 and the image data of the image 2. The related point detection unit 11 then executes the feature point matching on the image 1 and the image 2 to detect the equal to or more than three related point pairs {mᵢ, m′ᵢ; i∈{1, . . . , N}, N≥3}. The subscript “i” indicates a related number.

### [Step S3]

In step S3, the related figure detection unit 12 calculates the line lᵢ passing through the feature point mᵢ and the line l′ᵢ passing through the feature point m′ᵢ based on the above Expression 2 for each of mᵢ and m′ᵢ of the related point pair, and detects the M related figure pairs {lᵢ, l′ᵢ; i∈{1, . . . , N}, M=N}.

### [Step S4]

In step S4, the transformation matrix generation unit 13 generates the homography matrix based on the above Expression 4 by using the detected M (M≥3) related point pairs and N (N≥2) related figure pairs.

### Effects in First Example Embodiment

As described above, according to the first example embodiment, the homography matrix can be generated only by using at least three related point pairs obtained by the feature point matching. The reason is as follows.

From the three related point pairs, the six constraint conditions are obtained as indicated in the above Expression 1. By using two of the related figure pairs associated with the three related point pairs, the two constraint conditions are obtained as indicated in the above Expression 2. Therefore, the matrix H with the degree of freedom of 8 can be calculated based on the above Expression 4, and the effect described above can be obtained.

According to the first example embodiment, the accuracy in the generation of the homography matrix is higher than that of the method disclosed in JP 7448034 B2. This is because the homography matrix is generated by using only the positions and the angle information of the related point pair without using the scale information and the angle information having different error distributions in combination.

### [Program]

In the first example embodiment, the program may be any program that causes a computer to execute steps S1 to S5 illustrated in FIG. 5. When the program is installed and executed in the computer, the information processing apparatus 10 and the information processing method can be achieved. In this case, a processor of the computer functions as the related point detection unit 11, the related figure detection unit 12, the transformation matrix generation unit 13, the data acquisition unit 14, and the output unit 16, and performs processing.

The storage unit 15 may be achieved by a storage device such as a hard disk provided in the computer, or may be achieved by a storage device of another computer. Examples of the computer include a smartphone and a tablet terminal device in addition to a general-purpose PC and a server computer.

In the first example embodiment, the program may be executed by a computer system (such as a cloud system) constructed by a plurality of computers. In this case, for example, each computer may function as any one of the related point detection unit 11, the related figure detection unit 12, the transformation matrix generation unit 13, the data acquisition unit 14, and the output unit 16.

### Second Example Embodiment

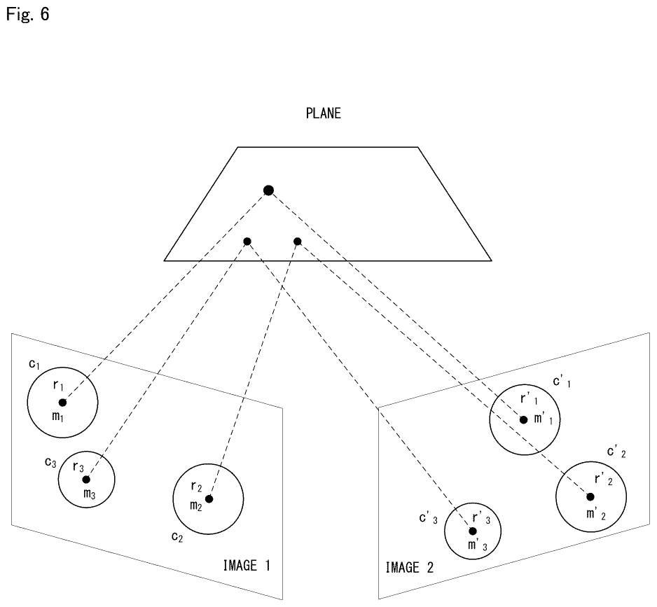

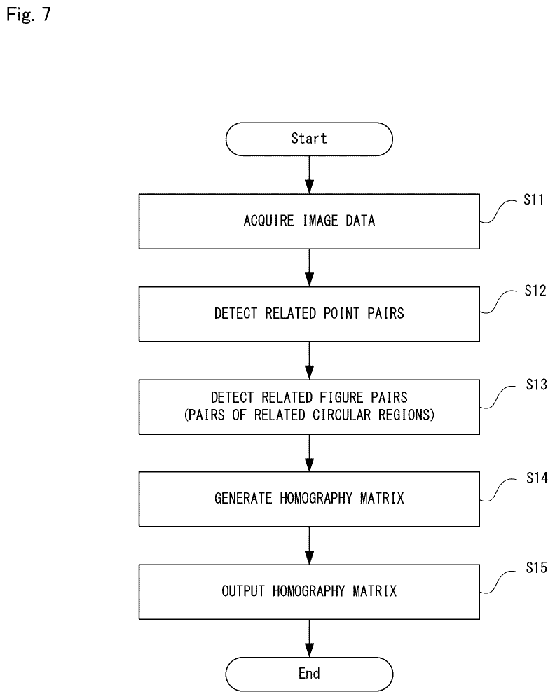

Next, an information processing apparatus, an information processing method, and a program in a second example embodiment will be described with reference to FIGS. 6 and 7.

### [Apparatus Configuration]

First, a configuration of the information processing apparatus will be described. First, also in the second example embodiment, the configuration of the information processing apparatus is similar to that of the information processing apparatus 10 illustrated in FIG. 2. In the following description, FIG. 2 and the reference signs illustrated in FIG. 2 will be referred to.

Also in the second example embodiment, similarly to the example illustrated in FIG. 2, the information processing apparatus includes a related point detection unit 11, a related figure detection unit 12, a transformation matrix generation unit 13, a data acquisition unit 14, a storage unit 15, and an output unit 16. However, in the second example embodiment, a function of the related figure detection unit 12 is different from that of the example of the first example embodiment. Hereinafter, the difference from the first example embodiment will be mainly described.

In the second example embodiment, for each related point pair, the related figure detection unit 12 detects a pair of regions related between images as a related figure pair by using a position and scale information of each feature point constituting the related point pair.

Specifically, the related figure detection unit 12 specifies, for each related point pair, a virtual circle centered on each feature point by using the position and the scale information of each feature point constituting the related point pair, and detects regions surrounded by the virtual circles as the related figure pair.

Here, the function of the related figure detection unit 12 will be described in detail with reference to FIG. 6. FIG. 6 is a diagram illustrating an example of the pair of regions related between the images. As illustrated in FIG. 6, it is assumed that the related point pair includes a feature point mᵢ in an image 1 and a feature point m′ᵢ in an image 2. In this case, by using the scale information (radius r), the related figure detection unit 12 specifies a region surrounded by a circle having a radius rᵢ centered on the feature point mᵢ, specifies a region surrounded by a circle having a radius r′ᵢ centered on the feature point m′ᵢ, and sets the specified two circular regions as the related figure pair. The subscript indicates a related number.

In the second example embodiment, the transformation matrix generation unit 13 generates a homography matrix by using equal to or more than three related line pairs and equal to or more than three related figure pairs (pairs of regions surrounded by circles) related to these related line pairs.

### [Apparatus Operation]

Next, operation of the information processing apparatus will be described with reference to FIG. 7. FIG. 7 is a flowchart illustrating a second example of the operation of the information processing apparatus. In the following description, FIGS. 2 and 6 will be appropriately referred to. Also in the second example embodiment, the information processing method is performed by operating the information processing apparatus. Therefore, description of the information processing method in the second example embodiment is also substituted with the following description of the operation of the information processing apparatus.

As illustrated in FIG. 7, first, the data acquisition unit 14 acquires, from an external device, image data of images obtained by imaging the same object from different directions (step S11). The data acquisition unit 14 stores each piece of the acquired image data in the storage unit 15. Step S11 is a step similar to step S1 indicated in FIG. 5.

Next, the related point detection unit 11 acquires image data of optional two images (the image 1 and the image 2) from the storage unit 15, executes feature point matching on each image of the acquired image data, and detects equal to or more than three related point pairs (step S12). Step S12 is a step similar to step S2 indicated in FIG. 5.

Next, for each related point pair detected in step S12, the related figure detection unit 12 detects a pair of related circular regions as a related figure pair by using a position and scale information of each feature point constituting the related point pair (step S13).

Specifically, in step S12, the related figure detection unit 12 specifies, for each related point pair, a virtual circle centered on each feature point by using the position and the scale information of each feature point constituting the related point pair, and detects a pair of regions (circular regions) surrounded by the virtual circles as the related figure pair.

Next, the transformation matrix generation unit 13 generates a homography matrix by using the equal to or more than three related point pairs detected in step S12 and the related figure pairs detected in step S13 (step S14).

Thereafter, the output unit 16 outputs the homography matrix generated in step S14 (step S15).

Also in the second example embodiment, in a case where it is needed to generate a homography matrix also between another two images, steps S12 to S15 are executed again. In this case, in step S12, the related point detection unit 11 acquires image data for a different combination of two images.

In step S14, the transformation matrix generation unit 13 can execute the generation of the homography matrix a plurality of times while changing the related figure pair to be used. The transformation matrix generation unit 13 then executes evaluation of accuracy for the plurality of generated homography matrices, and selects a homography matrix with the highest accuracy based on evaluation results.

### Specific Example

Here, a specific example of processing in the information processing apparatus in the second example embodiment will be described below. First, also in the second example embodiment, a homography of a feature point m and a feature point m′ as the related point pair is represented by the above Expression 1.

Subsequently, the related figure pair will be described. As described above, the feature point m has information related to the radius r centered on the feature point as the scale information. In the image 1, a circle C having center coordinates of (cᵤ, cᵥ) and a radius of r is represented by the following Expression 6 in a quadratic form. In the following Expression 6, a point x is an optional point on the circle C.

$${x}^{T} Cx = 0 C = [ \begin{matrix}1 & 0 & - {c}_{u} \\ 0 & 1 & - {c}_{v} \\ - {c}_{u} & - {c}_{v} & {c}_{u}^{2} + {c}_{v}^{2} - {r}^{2}\end{matrix} ] \qquad [ Expression 6 ]$$

Since x′˜Hx is obtained when the point x is subjected to a homography to a point x′ by a matrix H, the circle C is projected to a circle C′ as indicated in the following Expression 7.

$${x}^{T} Cx = {x}^{T} {H}^{T} {H}^{- T} {CH}^{- 1} Hx = {x}^{′ T} {Hx}^{′} = 0 \\ {C}^{′} ∼ {H}^{- T} {CH}^{- 1} \\ ↔ C ∼ {H}^{T} {C}^{′} H \qquad [ Expression 7 ]$$

Next, when a plurality of circles is present on the same plane and circles Cᵢ and Cⱼ relate to circles C′ᵢ and C′ⱼ, the following Expression 8 is obtained.

$${C}_{i}^{- 1} {C}_{j} ∼ {H}^{- 1} {C}_{i}^{′ - 1} {C}_{j}^{′} H ↔ {HC}_{i}^{- 1} {C}_{j} {C}_{i}^{- 1} {C}_{j}^{′} H = 0 \qquad [ Expression 8 ]$$

Here, since quadratic form representation of the circle has scale uncertainty, determinants are normalized to be equal to each other as indicated in the following Expression 9.

$$det ( {C}_{i} ) = det ( {C}_{j} ) , det ( {C}_{i}^{′} ) = det ( {C}_{j}^{′} ) \qquad [ Expression 9 ]$$

Therefore, when N related figure pairs are given, it is possible to estimate the matrix H by solving an optimization problem represented by the following Expression 10.

$${min}_{H} {\sum }_{i , j = 1 , i \neq j}^{N} {‖ {HC}_{i}^{- 1} {C}_{j} - {C}_{i}^{′ - 1} {C}_{j}^{′} H ‖}^{2} s . t . {‖ H ‖}^{2} = 1 \qquad [ Expression 10 ]$$

Six constraint conditions are obtained from the two related figure pairs {Cᵢ, Cⱼ}⇔{C′ᵢ, C′ⱼ} indicated in the above Expression 8. The number of combinations for selecting two pairs from the N related figure pairs without duplication is “_{N}C₂=N*(N−1)/2”. Therefore, in order to solve the above Expression 10, it is needed to satisfy the following Expression 11.

$$6 * N * ( N - 1 ) / 2 ≧ 8 \qquad [ Expression 11 ]$$

The minimum configuration satisfying the above Expression 11 is N=3. That is, when there are at least three related region pairs, the matrix H can be generated by solving the above Expression 10. Similarly to the above Expression 4, the above Expression 8 also results in DLT.

Here, steps S12 to S14 illustrated in FIG. 7 will be described in detail along the above specific example.

### [Step S12]

In step S12, the related point detection unit 11 acquires the image data of the image 1 and the image data of the image 2. The related point detection unit 11 then executes the feature point matching on the image 1 and the image 2 to detect the equal to or more than three related point pairs {mᵢ, m′ᵢ; i∈{1, . . . , N}, N≥3}.

### [Step S13]

In step S13, the related figure detection unit 12 detects, for each of mᵢ and m′ᵢ of the related point pair, N related circle pairs {Cᵢ, C′ᵢ; i∈{1, . . . , N}, N≥3} including the circle Cᵢ having center coordinates as the feature point mᵢ and a radius as the scale rᵢ of the feature point mᵢ and the circle C′ᵢ having center coordinates as the feature point m′ᵢ and a radius as the scale r′ᵢ of the feature point m′ᵢ, based on the above Expression 8.

### [Step S14]

In step S14, the transformation matrix generation unit 13 generates the homography matrix based on the above Expression 10 by using the detected N (N≥3) related figure pairs.

Unlike the above Expression 4, in the above Expression 8, it is not needed to consider a homography (the above Expression 1) of the coordinates of the positions of the related point pair. This is because the center coordinates, that is, the position of the coordinates of the feature point is included in the circle represented in the quadratic form, as indicated in the above Expression 6.

### Effects in Second Example Embodiment

As described above, according to the second example embodiment, the homography matrix can be generated only by using the three related figure pairs. The reason is as follows.

In a case where the two pairs are selected from the three related figure pairs, since the number of combinations is three, a total of 18 constraint conditions are obtained. Therefore, the matrix H with a degree of freedom of 8 can be calculated based on the above Expression 10, and the effect described above can be obtained.

Also in the second example embodiment, similarly to the first example embodiment, the accuracy in the generation of the homography matrix is higher than that of the method disclosed in JP 7448034 B2. This is because the homography matrix is generated by using only the positions and the scale information of the related point pair without using the scale information and angle information having different error distributions in combination.

### [Program]

In the second example embodiment, the program may be any program that causes a computer to execute steps S11 to S15 illustrated in FIG. 7. When the program is installed and executed in the computer, the information processing apparatus and the information processing method can be achieved. In this case, a processor of the computer functions as the related point detection unit 11, the related figure detection unit 12, the transformation matrix generation unit 13, the data acquisition unit 14, and the output unit 16, and performs processing.

The storage unit 15 may be achieved by a storage device such as a hard disk provided in the computer, or may be achieved by a storage device of another computer. Examples of the computer include a smartphone and a tablet terminal device in addition to a general-purpose PC and a server computer.

Also in the second example embodiment, the program may be executed by a computer system (such as a cloud system) constructed by a plurality of computers. In this case, for example, each computer may function as any one of the related point detection unit 11, the related figure detection unit 12, the transformation matrix generation unit 13, the data acquisition unit 14, and the output unit 16.

### (Modifications)

The first and second example embodiments described above are not limited to the examples described above. Various changes understandable by so-called those of ordinary skill in the art can be applied to the example described above. For example, the first and second example embodiments can also be performed by modes illustrated in the following modifications.

For example, in the first and second example embodiments, in a case where a related point pair includes an error (a misrelated point or an outlier), the misrelated point may be removed by using the RANSAC disclosed in JP 7448034 B2 and LO-RANSAC that is a derivative of the RANSAC.

In random sampling of three related point pairs, as in JP 7448034 B2, signed areas may be calculated by using the three related point pairs or three related figure pairs, and signs of the calculated signed areas may be compared to determine the misrelated point. In this case, the transformation matrix generation unit 13 determines whether to generate a homography matrix based on a determination result of the misrelated point. Since the RANSAC is a widely known technology, detailed description of the RANSAC will be omitted.

### (Physical Configuration)

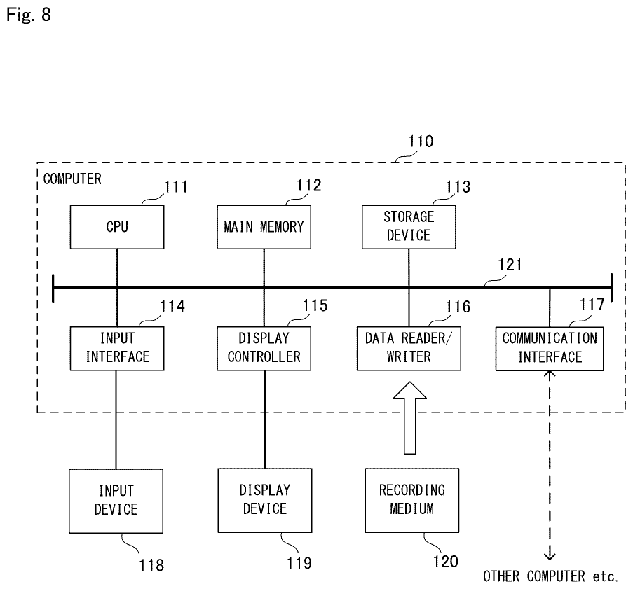

Here, a computer that achieves the information processing apparatus by executing the program in the first or second example embodiment will be described with reference to FIG. 8. FIG. 8 is a block diagram illustrating an example of the computer that achieves the information processing apparatus.

As illustrated in FIG. 8, a computer 110 includes a central processing unit (CPU) 111, a main memory 112, a storage device 113, an input interface 114, a display controller 115, a data reader/writer 116, and a communication interface 117. These units are data-communicably connected to each other via a bus 121.

The computer 110 may include a graphics processing unit (GPU) or a field-programmable gate array (FPGA) in addition to the CPU 111 or instead of the CPU 111. In this aspect, the GPU or the FPGA may execute the program in the example embodiment.

The CPU 111 loads the program in the example embodiment, which is stored in the storage device 113 and includes codes, into the main memory 112, and executes each code in predetermined order to perform various operations. The main memory 112 is typically a volatile storage device such as a dynamic random access memory (DRAM).

The program in the example embodiment is provided in a state of being stored in a computer-readable recording medium 120. The program in the present example embodiment may be distributed on the Internet connected via the communication interface 117.

Specific examples of the storage device 113 include a semiconductor storage device such as a flash memory in addition to a hard disk drive. The input interface 114 mediates data transmission between the CPU 111 and an input device 118 such as a keyboard and a mouse. The display controller 115 is connected to a display device 119 and controls display on the display device 119.

The data reader/writer 116 mediates data transmission between the CPU 111 and the recording medium 120, and reads a program from the recording medium 120 and writes a processing result of the computer 110 into the recording medium 120. The communication interface 117 mediates data transmission between the CPU 111 and another computer.

Specific examples of the recording medium 120 include a general-purpose semiconductor storage device such as Compact Flash (CF) (registered trademark) and a secure digital (SD), a magnetic recording medium such as a flexible disk, and an optical recording medium such as a compact disk read only memory (CD-ROM).

The information processing apparatus can also be achieved by using hardware related to each unit, for example, an electronic circuit, instead of the computer in which the program is installed. A part of the information processing apparatus may be achieved by a program, and the remaining part may be achieved by hardware. In the example embodiment, the computer is not limited to the computer illustrated in FIG. 8.

Some or all of the example embodiments described above can be represented by (Supplementary Note 1) to (Supplementary Note 15) described below, but are not limited to the following description.

### (Supplementary Note 1)

An information processing apparatus including:
a related point detection unit that extracts feature points having scale information and angle information from each of two images obtained by imaging the same object from different directions, and detects a pair of the feature points related between the images from among the feature points extracted from the two images;
a related figure detection unit that detects, for each pair of the feature points, a pair of figures that are derived from the feature points and are related between the images by using a position and one of the scale information and the angle information of each feature point constituting the pair; and
a transformation matrix generation unit that generates a homography matrix for transforming one of the images into the other by using equal to or more than three pairs of the figures related between the images.

### (Supplementary Note 2)

The information processing apparatus according to Supplementary Note 1, in which
the related figure detection unit specifies, for each pair of the feature points, a virtual line passing through each feature point by using the position and the angle information of each feature point constituting the pair, and detects the specified virtual lines of the feature points as the pair of figures related between the images.

### (Supplementary Note 3)

The information processing apparatus according to Supplementary Note 1, in which
the related figure detection unit specifies, for each pair of the feature points, a virtual circle centered on each feature point by using the position and the scale information of each feature point constituting the pair, and detects regions surrounded by the specified virtual circles of the feature points as the pair of figures related between the images.

### (Supplementary Note 4)

The information processing apparatus according to Supplementary Note 1, in which
the transformation matrix generation unit executes the generation of the homography matrix a plurality of times while changing the pair of lines related between the images and the pair of regions related between the images, and selects one of a plurality of the generated homography matrices.

### (Supplementary Note 5)

The information processing apparatus according to Supplementary Note 1, in which
the transformation matrix generation unit calculates signed areas by using at least three pairs of figures, and determines whether to generate the homography matrix by using signs of the calculated signed areas.

### (Supplementary Note 6)

An information processing method including:
a related point detection step of extracting feature points having scale information and angle information from each of two images obtained by imaging the same object from different directions, and detecting a pair of the feature points related between the images from among the feature points extracted from the two images;
a related figure detection step of detecting, for each pair of the feature points, a pair of figures that are derived from the feature points and are related between the images by using a position and one of the scale information and the angle information of each feature point constituting the pair; and
a transformation matrix generation step of generating a homography matrix for transforming one of the images into the other by using equal to or more than three pairs of the figures related between the images.

### (Supplementary Note 7)

The information processing method according to Supplementary Note 6, in which,
in the related figure detection step, for each pair of the feature points, a virtual line passing through each feature point is specified by using the position and the angle information of each feature point constituting the pair, and the specified virtual lines of the feature points are detected as the pair of figures related between the images.

### (Supplementary Note 8)

The information processing method according to Supplementary Note 6, in which,
in the related figure detection step, for each pair of the feature points, a virtual circle centered on each feature point is specified by using the position and the scale information of each feature point constituting the pair, and regions surrounded by the specified virtual circles of the feature points are detected as the pair of figures related between the images.

### (Supplementary Note 9)

The information processing method according to Supplementary Note 6, in which,
in the transformation matrix generation step, the generation of the homography matrix is executed a plurality of times while changing the pair of lines related between the images and the pair of regions related between the images, and one of a plurality of the generated homography matrices is selected.

### (Supplementary Note 10)

The information processing method according to Supplementary Note 6, in which,
in the transformation matrix generation step, signed areas are calculated by using at least three pairs of figures, and whether to generate the homography matrix is determined by using signs of the calculated signed areas.

### (Supplementary Note 11)

A computer-readable recording medium recording a program including a command for causing
a computer to execute:
a related point detection step of extracting feature points having scale information and angle information from each of two images obtained by imaging the same object from different directions, and detecting a pair of the feature points related between the images from among the feature points extracted from the two images;
a related figure detection step of detecting, for each pair of the feature points, a pair of figures that are derived from the feature points and are related between the images by using a position and one of the scale information and the angle information of each feature point constituting the pair; and
a transformation matrix generation step of generating a homography matrix for transforming one of the images into the other by using equal to or more than three pairs of the figures related between the images.

### (Supplementary Note 12)

The computer-readable recording medium according to Supplementary Note 11, in which,
in the related figure detection step, for each pair of the feature points, a virtual line passing through each feature point is specified by using the position and the angle information of each feature point constituting the pair, and the specified virtual lines of the feature points are detected as the pair of figures related between the images.

### (Supplementary Note 13)

The computer-readable recording medium according to Supplementary Note 11, in which,
in the related figure detection step, for each pair of the feature points, a virtual circle centered on each feature point is specified by using the position and the scale information of each feature point constituting the pair, and regions surrounded by the specified virtual circles of the feature points are detected as the pair of figures related between the images.

### (Supplementary Note 14)

The computer-readable recording medium according to Supplementary Note 11, in which,
in the transformation matrix generation step, the generation of the homography matrix is executed a plurality of times while changing a pair of lines related between the images and a pair of regions related between the images, and one of a plurality of the generated homography matrices is selected.

### (Supplementary Note 15)

The computer-readable recording medium according to Supplementary Note 11, in which,
in the transformation matrix generation step, signed areas are calculated by using at least three pairs of figures, and whether to generate the homography matrix is determined by using signs of the calculated signed areas.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

As described above, according to the present disclosure, it is possible to suppress a decrease in accuracy of a homography matrix in generation of the homography matrix using two related point pairs. The present disclosure is useful for a computer system in which image processing is required.

1. An information processing apparatus comprising:
at least one memory storing instructions; and
at least one processor configured to execute the instructions to:
extract feature points having scale information and angle information from each of two images obtained by imaging the same object from different directions, and detect a pair of the feature points related between the images from among the feature points extracted from the two images;
detect, for each pair of the feature points, a pair of figures that are derived from the feature points and are related between the images by using a position and one of the scale information and the angle information of each feature point constituting the pair; and
generate a homography matrix for transforming one of the images into the other by using equal to or more than three pairs of the figures related between the images.

2. The information processing apparatus according to claim 1, wherein
at least one processor specifies, for each pair of the feature points, a virtual line passing through each feature point by using the position and the angle information of each feature point constituting the pair, and detects the specified virtual lines of the feature points as the pair of figures related between the images.

3. The information processing apparatus according to claim 1, wherein
at least one processor specifies, for each pair of the feature points, a virtual circle centered on each feature point by using the position and the scale information of each feature point constituting the pair, and detects regions surrounded by the specified virtual circles of the feature points as the pair of figures related between the images.

4. The information processing apparatus according to claim 1, wherein
at least one processor executes the generation of the homography matrix a plurality of times while changing a pair of lines related between the images and a pair of regions related between the images, and selects one of a plurality of the generated homography matrices.

5. The information processing apparatus according to claim 1, wherein
at least one processor calculates signed areas by using at least three pairs of figures, and determines whether to generate the homography matrix by using signs of the calculated signed areas.

6. An information processing method comprising:
extracting feature points having scale information and angle information from each of two images obtained by imaging the same object from different directions, and detecting a pair of the feature points related between the images from among the feature points extracted from the two images;
detecting, for each pair of the feature points, a pair of figures that are derived from the feature points and are related between the images by using a position and one of the scale information and the angle information of each feature point constituting the pair; and
generating a homography matrix for transforming one of the images into the other by using equal to or more than three pairs of the figures related between the images.

7. The information processing method according to claim 6, in which,
in the related figure detection, for each pair of the feature points, a virtual line passing through each feature point is specified by using the position and the angle information of each feature point constituting the pair, and the specified virtual lines of the feature points are detected as the pair of figures related between the images.

8. The information processing method according to claim 6, in which,
in the related figure detection, for each pair of the feature points, a virtual circle centered on each feature point is specified by using the position and the scale information of each feature point constituting the pair, and regions surrounded by the specified virtual circles of the feature points are detected as the pair of figures related between the images.

9. The information processing method according to claim 6, in which,
in the transformation matrix generation, the generation of the homography matrix is executed a plurality of times while changing the pair of lines related between the images and the pair of regions related between the images, and one of a plurality of the generated homography matrices is selected.

10. The information processing method according to claim 6, in which,
in the transformation matrix generation, signed areas are calculated by using at least three pairs of figures, and whether to generate the homography matrix is determined by using signs of the calculated signed areas.

11. A non-transitory computer-readable recording medium recording a program including a command for causing a computer to:
extract feature points having scale information and angle information from each of two images obtained by imaging the same object from different directions, and detect a pair of the feature points related between the images from among the feature points extracted from the two images;
detect, for each pair of the feature points, a pair of figures that are derived from the feature points and are related between the images by using a position and one of the scale information and the angle information of each feature point constituting the pair; and
generate a homography matrix for transforming one of the images into the other by using equal to or more than three pairs of the figures related between the images.

12. The non-transitory computer-readable recording medium according to claim 11, in which,
in the related figure detection, for each pair of the feature points, a virtual line passing through each feature point is specified by using the position and the angle information of each feature point constituting the pair, and the specified virtual lines of the feature points are detected as the pair of figures related between the images.

13. The non-transitory computer-readable recording medium according to claim 11, in which,
in the related figure detection, for each pair of the feature points, a virtual circle centered on each feature point is specified by using the position and the scale information of each feature point constituting the pair, and regions surrounded by the specified virtual circles of the feature points are detected as the pair of figures related between the images.

14. The non-transitory computer-readable recording medium according to claim 11, in which,
in the transformation matrix generation, the generation of the homography matrix is executed a plurality of times while changing a pair of lines related between the images and a pair of regions related between the images, and one of a plurality of the generated homography matrices is selected.

15. The non-transitory computer-readable recording medium according to claim 11, in which,
in the transformation matrix, signed areas are calculated by using at least three pairs of figures, and whether to generate the homography matrix is determined by using signs of the calculated signed areas.
